(19) United States
(12) Patent Application Publication
(10) Pub. No.: US 2013/0284036 A1
(43) Pub. Date: Oct. 31, 2013

(54) PERSONAL USE SCREEN PRINTING SYSTEM, METHOD, AND DEVICE

(71) Applicants: AZHELLE WADE, Nutley, NJ (US); Emmanuel Valdez, Dunellen, NJ (US)

(72) Inventors: AZHELLE WADE, Nutley, NJ (US); Emmanuel Valdez, Dunellen, NJ (US)

(21) Appl. No.: 13/658,470

(22) Filed: Oct. 23, 2012

Related U.S. Application Data
(60) Provisional application No. 61/553,349, filed on Oct. 31, 2011.

(51) Int. Cl. B41F 15/08

(52) U.S. Cl. CPC B41F 15/08
USPC 101/123; 101/129

(57) ABSTRACT

The invention relates to a printing device, system, kit, and method for screen printing indicia on surfaces. More particularly, the present invention provides a hand-held, ink applicator in a sealed pouch combined with a rigid backing member for applying indicia on a surface via use with a screen printing stencil member, and a method for utilizing same.

### CROSS REFERENCE TO RELATED APPLICATIONS

This application claims priority to the U.S. Provisional Application Ser. No. 61/553,349, filed on Oct. 31, 2011, the entirety of which is hereby incorporated by reference.

### BACKGROUND OF THE INVENTION

1. Field of the Invention

This invention relates to a system, method, and device for screen printing of surfaces, such as T-shirts and the like, and may be provided in a kit form additionally with a stencil member in a suitable container. More particularly, the present invention provides a disposable, single or multi-use use kit that includes at least one screen sheet printed with design patterns, a hand-held, disposable indicia ink applicator utilizing a squeegeeing technique and method for utilizing same.

2. Description of the Related Art

Silk screen printing is a conventional printing technique that uses an ink-blocking stencil or mesh screen fabric that forms patterned open areas that allow for the transfer of ink or other indicia media which can be pressed through the stencil providing a sharp-edged indicia image onto a surface or a substrate. Ink is fluidly-applied as a pool or huddle of fluid ink poured onto the screen stencil, and a squeegee is used to force or press the ink past and through the threads of the woven mesh screen onto the open areas for printing. Generally, screen printing is a stencil method of print making in which a design is imposed on a screen of crafted of fine mesh, with blank areas coated with an impermeable substance, and ink is forced through the mesh onto the printing surface, and the screen then removed. While a common use for silk screen printing is for textiles or garments, the technique is used on thousands of items, including solid surface consumer items such as clock and watch faces, balloons, and many other products. The technique has even been adapted for more advanced uses, such as laying down conductors and resistors in multi-layer circuits using thin ceramic layers as the substrate.

A variety of inks may be used in the screen printing process. Some such inks include: magnetic ink—of the type disclosed in U.S. Pat. No. 7,192,628, which is hereby incorporated by reference in its entirety; discharge inks—used to print lighter colors onto dark background fabrics, they work by removing the dye in the garment—this means they leave a much softer texture; expanding ink (puff)—an additive to plastisol inks which raises the print off the garment, creating a 3D look and feel; flocking—consisting of a glue printed onto the fabric and then foil or flock (or other special effect) material is applied for a mirror finish or a velvet touch; four color process or the CMYK color model—artwork is created and then separated into four colors (CMYK) which combine to create the full spectrum of colors needed for photographic prints; glitter/shimmer—metallic flakes are suspended in the ink base to create this sparkle effect; gloss—a clear base laid over previously printed inks to create a shiny finish; metallic—similar to glitter, but smaller particles suspended in the ink; mirrored silver—a highly reflective, solvent based ink; nylobond—a special ink additive for printing onto technical or waterproof fabrics; plastisol—the most common ink used in commercial garment decoration; PVC and Phthalate Free—ink having the benefits of plastisol but without the two main toxic components; suede ink—suede is a milky colored additive that is added to plastisol; and water-based inks—which penetrate the fabric more than the plastisol inks and create a much softer feel.

Screen printing is a versatile printing technique. The surface does not have to be printed under pressure and it does not have to be planar. Screen printing inks can be used to work with a variety of materials, such as textiles, ceramics, wood, paper, glass, metal, and plastic. As a result, screen printing is used in many different industries, including: Balloons, Clothing, Decals, Medical devices, Printed electronics, including circuit board printing, Product labels, Signs and displays, Snowboard graphics, Textile fabric, Thick film technology, and Semi-conductors material.

Traditionally, garment decoration has relied on screen printing for printing designs on garments including t-shirts; recently, new methods and technologies have become available. Digital printing directly onto garments using modified consumer-quality, and task-specific designed inkjet printers. Screen printing, however, has remained an attractive, cost-effective, and high production-rate method of printing designs onto garments. Digital printing directly onto garments is referred to as DTG or DTS representing Direct To Garment or Direct To Shirt. DTG or DTS direct printing has advantages and disadvantages compared to screen printing. One noted advantage of DTG/DTS is number of visually perceived colors and the obvious photo-reproduction and photo-like print. DTG/DTS is often WYSIWYG (an acronym far What You See Is What You Get), whereas screen printing often requires skilled artistic modification and then must be photo reproduced onto screens and printed. DTG/DTS has the advantage of quick one-off designs and small quantity orders where the screen printing process involves several independent time consuming steps. Screen printing is a production method and quickly overtakes DTG/DTS in cost per print as the higher the volume the lower cost per print becomes, screen printing also has the advantage of a large selection of different types of inks that are all considerably less expensive per garment than DTG/DTS inks.

Screen printing of T-shirts and the like is typically carried out in the following manner. A printing screen is constructed by covering a frame with a screen of very fine mesh, usually constructed of silk, nylon or similar filament. The holes in the screen are selectively filled by well-known procedures so as to leave unfilled holes in the pattern of design to be printed. The T-shirt to be printed on is placed on a table or shirt board and the screen placed on top of the shirt. A suitable ink is then spread across the screen in fluid form and pressed through the holes in the screen with a squeegee. This leaves the desired ink pattern on the shirt.

Known techniques for screen printing of T-shirts and the like are time consuming and difficult, and extremely costly where mechanisms are used. For example, screen printing utilizing a vacuum has been applied in the past to paper.

Used in conjunction with the screen printing process are stenciled designs. These are typically applied to a surface, for example an article of clothing, and paint or ink can be applied through the cutout design onto the surface. These stencils are formed with cutout areas that correspond to various portions of the design to be created, In applying the design, the stencil or stencils usually are taped or otherwise secured to the surface where the stenciled design is to be applied. Commonly, the paint or ink is applied through the cutout areas with a brush or a sponge. However, paint is sometimes applied by different means such as, for example, by spraying the paint through the cutout areas or by rolling the paint over the stencil and through the cutout areas. In any event, the paint is applied to the surface through the cutout areas of a stencil, whereupon the stencil is removed leaving the resulting design on the surface.

A general consequence of the use of prior art methods has been that skillful application of high quality designs comes only after substantial experience in applying the designs, as a process of physical skill. It has been difficult in the past for a novice or inexperienced person to apply the designs with the same quality results as an experienced application. Also, to print multiple copies of the screen design on garments in an efficient manner, amateur and professional printers usually use a screen printing press. Many companies offer simple to sophisticated printing presses. Most of these presses are manual. A few industrial-grade-automatic printers require minimal manual labor and increase production significantly but such devices are expensive and bulky—designed for the mass producer—and not convenient or economical for individual users.

Accordingly, there exists a need for an inexpensive, convenient, and easy-to-use method, kit, and device that addresses the problems and shortcomings of the prior methods and apparatuses.

### ASPECTS AND SUMMARY OF THE INVENTION

The invention relates to a ready to use screen printing system, device, kit, and method that includes a tacky screen of a design pattern (screen), and a single-use or multi-use hand-held indicia-printing device. More particularly, the present invention provides a full set of ready to use, disposable use printing kits which provides a printed pattern on any object in a matter of minutes, and may optionally be combined multiple ink containers or packets in a kit form.

In accordance with one aspect of this invention, a hand-held, screen ink and applicator utilizing a squeegeeing feature and structure, and method for utilizing same, is provided. An applicator device is provided which comprises an ink packet affixed to or removably-attached to a rigid backing or substrate member. The ink packet is attached in a manner that during use enable the rigid substrate or backing to act as an integrated squeegee as the ink is pressed out of the packet and onto the surface to provide an even amount of ink over the desired surface. In accordance with one aspect of the invention, the applicator is disposable. In accordance with one aspect of the invention, the applicator is multi-use, and for example, may be re-sealable between uses.

In still another aspect of the invention, one or more screen designs may be provided along with the applicator device (or devices to include multiple color ink packets) to comprise a complete screen printing system, set or kit. The screen printing set in accordance with the present invention may include one or more stencil design sheets of various designs, optionally made of substantially transparent plastic, such that each stencil sheet has a distinct portion of the overall design represented by cutout areas in the sheet. The patterned screen sheets are provided preferably with a releasably-self-sticky side to be easily amounted to a surface to-be-printed.

This would enable the user to readily apply different colors to different portions of the overall design. The sheets may be used in sequence to apply the design to a surface and with each sheet the portions of the design not being immediately applied to the surface are visible to the user on the stencil sheet itself. That is, a first stencil sheet may be for application of a first portion of the design to the surface and has cutout portions corresponding to the first portion of the design. Similarly, a second stencil sheet may be for application of a second portion of the design to the surface and has cutout areas corresponding to the second portion of the design. Of course, more than two stencil sheets may be used as well.

Once the first portion of the design is applied through the cutout areas of the first stenciled sheet, this stencil sheet is removed and the ink is allowed to dry. Once dry, the second stencil sheet is applied. The design on the second stencil sheet is aligned with the previously applied design by aligning the previously applied first portion of the design with that portion as printed on the second stencil sheet. In this manner, near perfect alignment is easily achieved. The second portion of the design can then be applied through the cutout areas of the second stencil sheet.

One aspect of the present invention is to provide an inexpensive reliable apparatus, device, kit, and method for screen printing on any other textile articles.

Another aspect of the present invention is to provide an applicator device for screen printing that is inexpensive and optionally disposable while also enabling a multi-use configuration.

Another aspect of the present invention is to provide an applicator device for screen printing that is inexpensive but may be reused, or may be multi-use, and may optionally include a resealable feature.

Another aspect of the invention is to provide a screen printing applicator device and method that is easy to use.

Another aspect of the invention is to provide a complete screen printing kit comprising a variety of ink colors and screen designs.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1A shows a perspective view of a screen ink-applicator having a pre-cut opening, sealedly packaged within a wrapping housing in accordance with an alternative aspect of the present invention;

FIG. 1B shows a ready to use, self-sticky screen sheet with a pre-designed pattern in accordance with the present application, and it will be understood that the applicator may be co-packaged with the screen sheet in a kit form which is why a box line is provided for FIG. 1A and FIG. 1B;

FIG. 2A shows a perspective view of another example screen ink-applicator without a pre-cut opening, but a simple ready to use by cutting or tear-open the ink bag and applicator in accordance with the present application;

FIG. 2B shows a side sectional view of the screen ink-applicator shown in FIG. 2A noting the ink bag or container is secured on a portion of the applicator substrate;

FIG. 3 shows a perspective view of an example screen ink-applicator having a pre-cut, packaged within a housing in accordance with this application;

FIG. 4A shows a plan view of an exemplary wrapping and sealing package for a pre-cut screen ink-applicator in accordance with this application;

FIG. 4B shows a top view of an example pre-cut screen ink-applicator sealed with a self-sticky paper strip, for access removal, in accordance with this application;

FIG. 4C shows a top view of another example pre-cut screen ink-applicator having an enlarged applicator edge (both sides extending beyond a width of an applicator) for higher efficiency in accordance with this application;

FIG. 5 shows a flow diagram of the method for applying the ink indicia to a desired surface using the applicator in according to the present invention;

FIG. 6 illustratively shows a screening printing arrangement or process using a screen printing kit as described in this application, where ink flow is noted flowing from the pouch onto the applicator for applying to the substrate via the pattern;

FIG. 7 shows a series of images of an exemplary screen printing process using a screen printing kit as described in this application;

FIG. 8 shows an example result of printing a design pattern indicial on a textile member (here a T-shirt) using a screen printing kit as described in this application.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

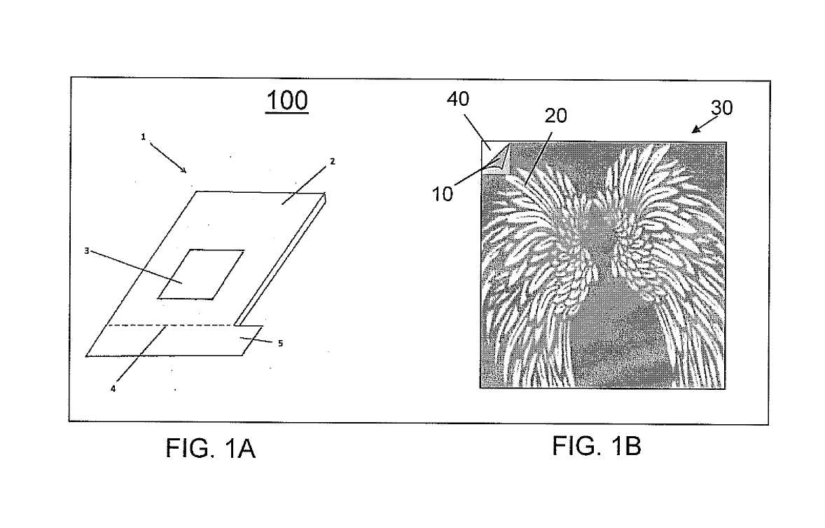

Referring first to FIG. 1, shown is a screen printing kit 100 that includes a screen ink-applicator 1 and a pre-designed pattern sheet 10.

As depicted in the perspective view, the screen ink-applicator device 1 may comprise a housing 2 which is preferably removable and substantially surrounds the ink packet 3, and a detachable tear sealing strip 5 that seals a pre-cut ink packet 3. The sealing side of the strip 5 may be coated with a layer of adhesive material to tightly seal the pre-cut opening of packet 3.

Pre-designed pattern sheet 30 may comprise two layers of sheet materials, a smooth plastic sheet 40 and a pre-patterned sheet 10 that is made of fine mesh like fabric material where the darker areas are paint-blocked and the light areas are paint-penetrable. Sheet 10 may be configured to be self-sticky in order to be easily attached into a surface, and sheet 40 is attached to the sticky side of sheet 10 to protect the glue material and to allow sheet 10 to be freshly peeled off to attach to the surface to be painted with the pattern that sheet 10 provides.

The screen ink-applicator 1 may contain a pre-cut opening on the ink-packet 3 ready to use or it may contain a sealed ink-packet 3 that needs to be cut open before using.

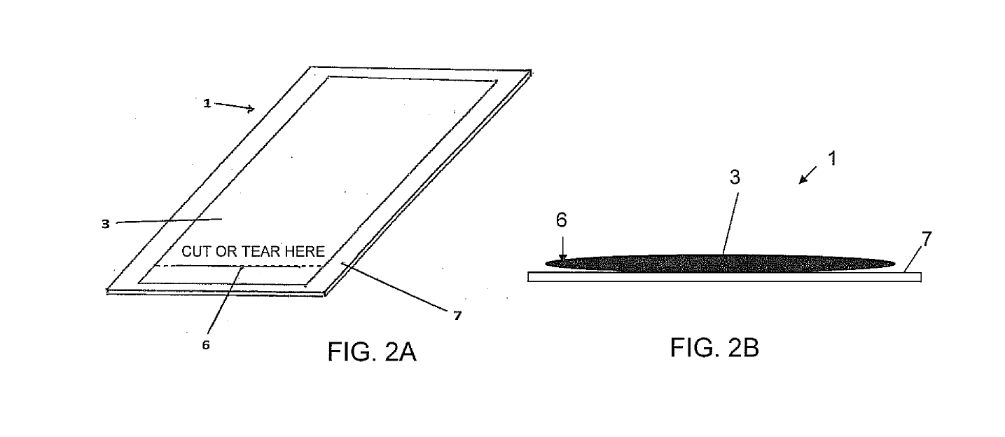

As shown in FIG. 2A, a screen ink-applicator 1 that contains a sealed ink-packet 3 may not need to be housed in a housing wrap. An ink-packet 3 may be simply fixedly attached onto a hard flat support 7 as shown in FIG. 2B. At the time of screen painting, packet 3 may be cut open at position 6, and ink may flow out from the opening to be applied to the screen sheet 10 to penetrate to a surface to print the pattern of sheet 10 to that surface.

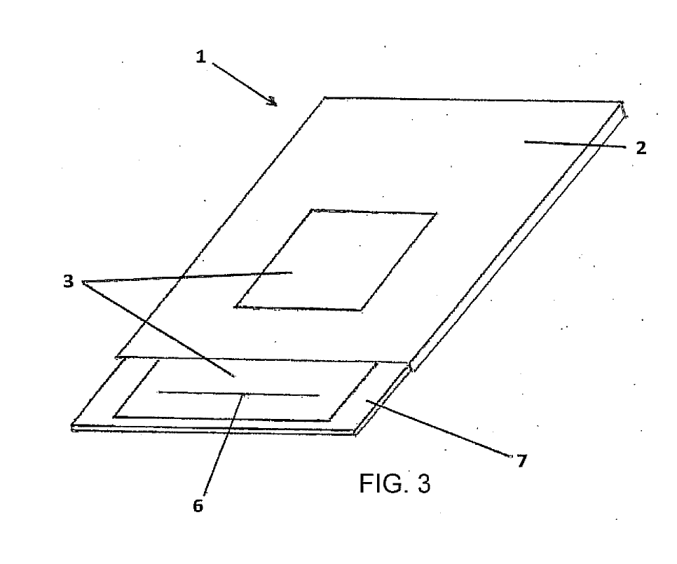

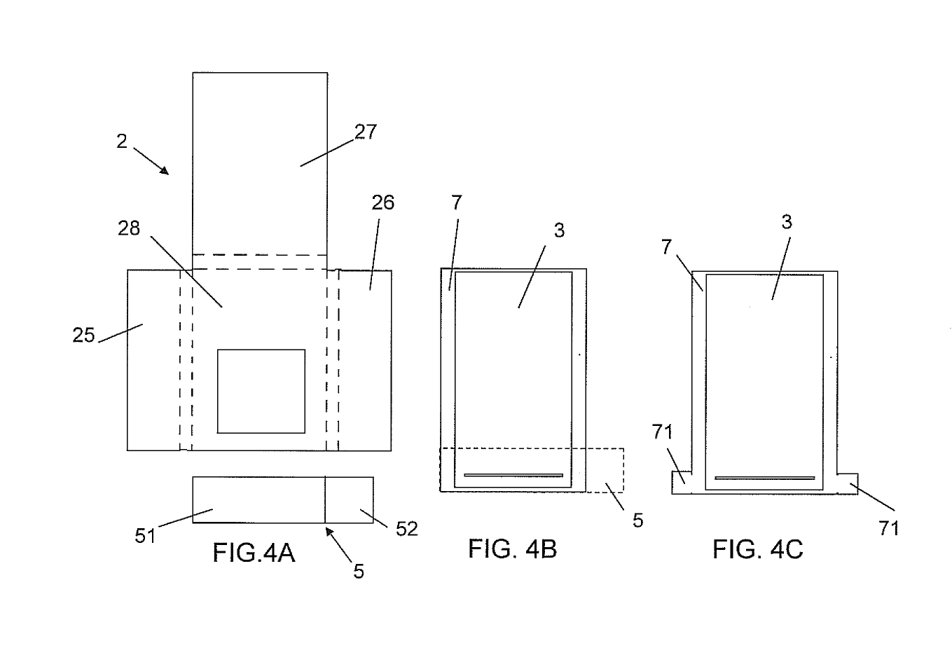

For a screen ink-applicator 1 that contains a pre-cut opening on the ink-packet 3, a housing 2 may be provided to provide aesthetic packaging and a sealing strip 5 is attached to seal the opening 6 (FIG. 4B). As shown in FIG. 3, housing 2 may comprise a window or opening through which the color of the ink in packet 3 may be viewed. Housing 2 also preferably comprises a tear strip 5, which may be removed from housing 2 without removing housing 2 to expose a portion of ink packet 3 and support 7 such that the applicator 1 may be used without removing all of housing 2.

As shown in FIG. 3, once the tear strip 5 is removed from housing 2, a portion of packet 3 and support 7 are exposed. To ready the applicator 1 for use, a small opening 6 is created in packet 3 near the bottom edge. As shown in FIG. 3, applicator 1 may optionally be used with housing 2 fully removed.

As shown in FIG. 4A, housing 2 is preferably made from a lightweight and disposable material, such as cardboard, and is cut into a shape that can be easily folded into a housing, with sides 27, 25, 26 and 28 which are capable of having letters or designs printed thereon. Adhesive materials may be applied to sides 25, 26 and 27 to allow for permanent shape of a housing structure. Preferably, the tear strip 5 portion of housing 2 has a perforated line 4 for ease in tearing the tear strip 5 from housing 2.

FIG. 4C shows an alternative support 7 that has an enlarged applicator edge 71 nearing the opening of the ink packet 3, allowing for larger ink-application upon each strike.

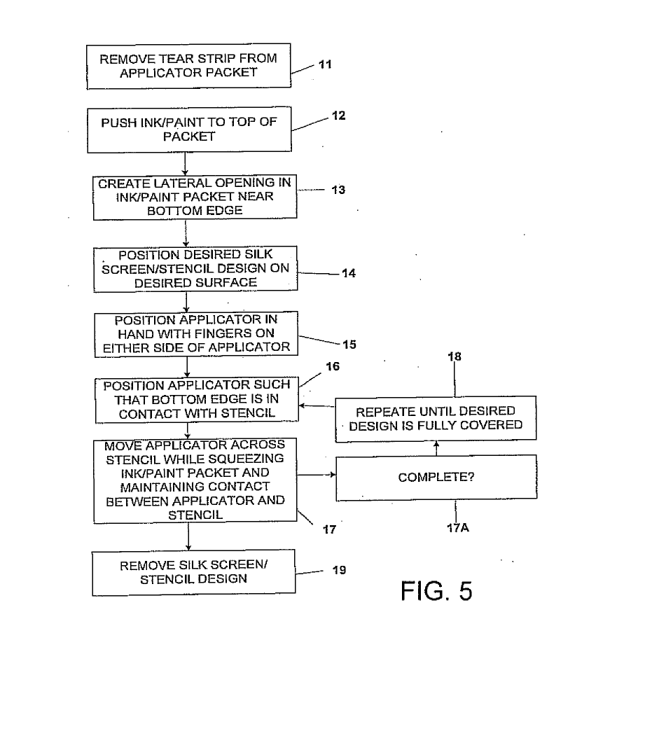

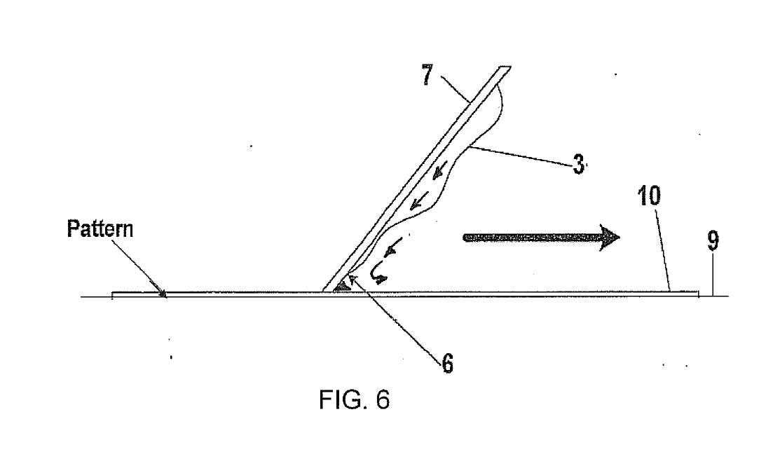

When in use, screen painting kit 100 is opened, and if the kit contains an ink-applicator of FIG. 2A with a sealed ink-packet 3, ink-packet 3 is cut-open to form a slit at the position 6, then the ink is applied by scrapping the ink unto a pattern sheet 10 surface to paint the pattern onto the surface (as shown in FIG. 6). If the kit contains a pre-cut ink-packet 3 and an ink-applicator of FIG. 1A, the method of FIG. 5 is followed.

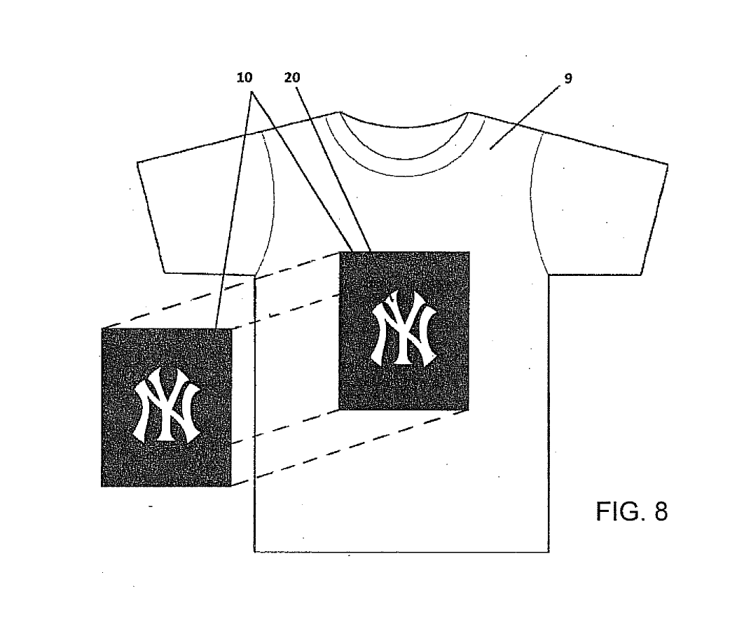

Referring additionally to FIGS. 5-6, the method of applying a screen print design to a surface using the applicator in accordance with the present invention is shown and described. That is, the desired screen design 10 is positioned and optionally affixed in place on the surface of, for example, shirt 9 in FIG. 8 where the design is to be placed (step 14). Applicator 1 is opened by tearing tear strip 5 from housing 2 thereby exposing a lower portion of ink packet 3 and support 7 (step 11). In the preferred method, the user first pushes the ink in packet 3 toward the upper end of packet 3 (step 12), so that a small opening 6 can be created in packet 3 near the lower end of packet 3 (step 13). It will be appreciated that the opening 6 in packet 3 is preferably a thin lateral cut in packet 3 extending substantially across the width of packet 3.

If not already done, the user should position the desired screen design 10 in place on the surface of, for example, shirt 9 where the design is to be placed (step 14). The user then holds applicator 1 between the thumb and fingers preferably such that the thumb presses on packet 3 while the fingers press on the support 7 (step 15). This positioning will enable the user to depress on the packet 3 to force the ink out of the packet 3 through opening 6 at the desired time. Then, the user, while holding the applicator 1 and just discussed, positions the applicator 1 adjacent the screen 10 such that the bottom edge of support 7 comes in contact with screen 10 (step 16).

Once applicator 7 is in the desired location on screen 10, the user moves the applicator 7 in a generally longitudinal direction across screen 10 while depressing on packet 3 such that ink is forced out of packet 3 into the cutout 20 of screen 10 (step 17). The user preferably maintains contact between the bottom edge of support 7 and screen 10 while ink is being forced out of packet 3 and onto screen 10. This will allow the bottom edge of support 7 to act as a squeegee thereby sweeping away any excess ink on screen 10 while pushing such ink into the cutout 20 in screen 10 and onto the desired surface 9. The user then determines of ink has been forced into the entire design on screen 10 (step 17A), and then repeats step 17 until the entire cutout 20 on screen 10 has been filled with ink (step 18). Once the user determines that ink has been supplied to the entire cutout 20, the screen 10 may be removed from surface 9 so that it may dry. Optionally, the user may then use a second design screen of a different design and repeat the process with the same or a different color ink.

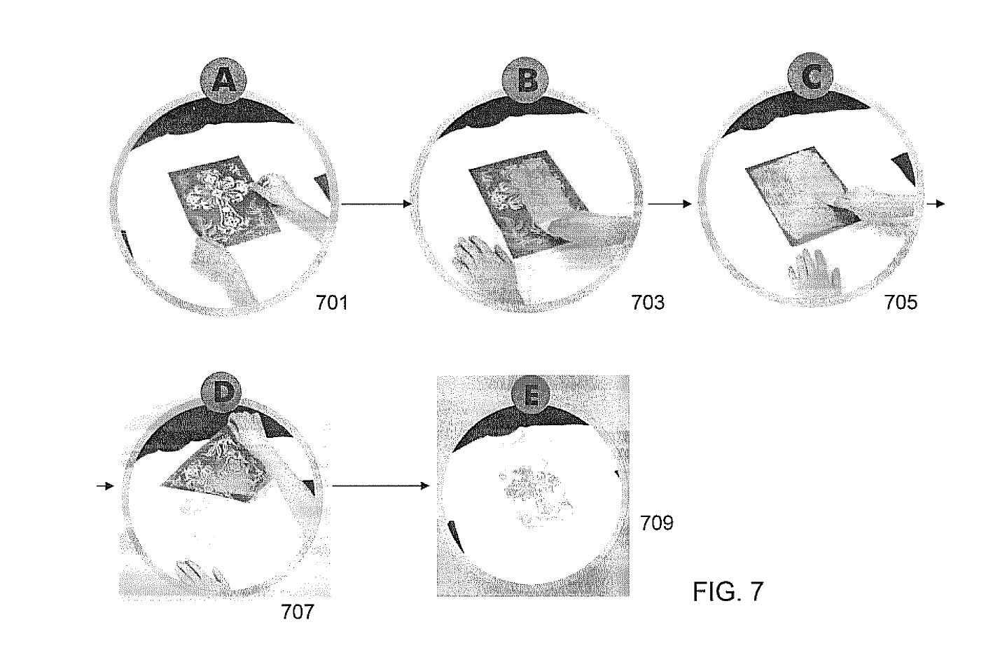

FIG. 7 shows a series of snap shots for screen-printing a flower pattern onto a T-shirt in a matter of minutes. A screen printing kit is bought with the desired flower pattern sheet at 701, the pattern sheet is peeled off to be adhered to the shirt surface. An ink-applicator with an ink packet of the desired color is selected and opened, and the ink is applied to the pattern sheet by scrapping across the pattern sheet to cover the sheet with the ink at 703, and 705. Care should be taken not to stain the shirt with the ink not covered with the pattern sheet. The stained screen sheet is peeled off the T-shirt at 707, leaving an ink-printed pattern on the T-shirt at step 709.

The screen sheet may be designed to any pattern by print-blocking the mesh-like fabrics. For example, in FIG. 8, shown a is a perspective view of a typical print screen or stencil design 10 of a NY sport team's logo positioned on a shirt 9 ready for application of the ink or paint using the applicator 1. Of course, the invention is not limited for use with shirts and other garments but may also be used to apply a design to other surfaces as well. It will also be appreciated by persons having skill in the art that any number of different designs may be used in accordance with the invention. Also, as discussed below, multiple screens may be used each with a different portion of the design such that different colors may be accurately used for different portions of the overall design.

For example, the screen printing system may optionally comprise a first screen and a second screen. The screens are preferably made of thin, substantially transparent plastic sheet material that is light, inexpensive, and durable. However, the screens could be formed of any substantially transparent material. Further, while two screens are discussed here for clarity of explanation and description of the invention, it will be understood that the present invention may be embodied in screen sets of three or more screens, depending upon the complexity of the finished design to be applied and the number of different colors to be used to complete the design. For example, a screen set may be designed for the application of a red rose to a surface, where the rose both a flower and a stem. In reality, the red rose would be colored red (or any other colored rose), while the stem would be colored shades green.

While a simple flower design made up of two portions has been discussed for clarity of explanation, it will be understood that designs of any desired level of complexity and with any number of different portions can be achieved through application of the present invention. For example, a cluster of roses might be applied with five different portions of the design to be colored five different colors of roses. Such a complex design could be applied easily with the present invention with five stencil sheets, each having cutout areas corresponding to a different portion of the design, and using five different applicators each with a different one of the five desired color inks. Accordingly, the simplicity of the present invention allows for the simple and efficient application of multiple color inks to various parts of a design to be applied to a surface.

Registration lines are optionally printed on the sides of the screens, for purposes of aligning and registering the designs on the two screens. The registration lines are positioned on the screens so that when the second screen is laid atop the first screen and the lines are registered with each other, then the visibly depicted portions of the image on each sheet align with and show through the corresponding cutout portion on the other sheet. Thus, when the two sheets are overlaid and registered, a complete image of the finished design as it should look when applied to the surface is presented, and there is no need for a separate printed depiction of the finished design.

In another embodiment of the present invention, the applicator and screen print designs may be assembled into a complete kit. For example, referring again to the multiple rose example discussed above, a screen print system or kit may preferably comprise a plurality of applicators of various colors, each designed in accordance with applicator 1, and a plurality of print screens each having a rose design cutout which may be used together or individually to create variety of different colored designs. Alternatively, any number of different sizes, shapes, colors, designs, etc. may be used in accordance with the invention.

As shown in FIGS. 5-7, during use of the present invention to apply a screen print design to a surface such as a shirt, the user may first position or otherwise affix the screen to the surface where the design is to be applied. If more than one screen is to be used, a second screen can then be positioned over and registered with the first screen if desired so that a complete image of the design can be viewed against the surface. The color to be applied with the screen is ascertained, and the second screen may be removed so that applicator 1 having a first color may be used to apply ink through the cutout areas of the first screen onto the surface to apply the first portion of the design to the surface. Alternately, the screens may be labeled (for example, 1, 2, 3, etc.) and a color key is provided, for example, with an instruction sheet which instructs to “apply color red with screen 1”, “apply color green with screen 2”, “apply color blue with screen 3” etc. Because the screens are preferably substantially transparent, as the ink is applied, the user can easily judge the relationship between the ink being applied and the color of the other portions of the design to be applied later. Thus, color, hue, and texture matching can easily be accomplished as the ink is being applied without referring to a separate printed drawing.

Once the ink has dried on the surface, the second screen is then positioned or otherwise affixed to the surface overlying the previously applied first portion of the design. In order to align the second screen with the applied first portion, the user need only line up the visibly depicted portion with the first portion of the design that was previously applied to the surface. Upon such alignment, the second portion of the design corresponding to the cutout portion in the second screen is properly aligned and oriented with respect to the previously applied first portion. Using applicator 1 having a second color ink, ink is then applied through the cutout portion in the second screen to complete the design on the surface.

The screen print system and method according to this embodiment of the invention has been found to be superior to prior art methods because, in part, the need to judge color characteristics of a color being immediately applied relative to colors of the design not being immediately applied by referring to separate printed drawings of the final design is eliminated. Rather, the portions of the final design not being immediately applied are always visible to the user right on each screen as the design is being applied. The result is a completed design wherein the elements are properly aligned with respect to each other and display color combinations that are true and accurate. The present invention is found to be useful and helpful to novices and those with little experience in applying such screen print designs.

The invention has been described in terms of preferred embodiments and methodologies. It will be obvious to those of skill in this art, however, that various modifications or extensions may be made to the illustrated embodiments. As mentioned above, for example, three, four, or even more stencil sheets could be used to create complex designs having many portions of different colors.

These alternative operative constructions include, as non-limiting examples, re-sealable pouches, or the provision of a series of pouches that may be adaptively and operatively releasably secured to an application, with a hook+loop system (Velcro for example), or with other means. In this series system, multiple ink pouches may be sold with a single substrate, and a user-selection may occur for a desired ink for use with a particular stencil.

It will also be understood that the phrases used herein are descriptive and non-limiting in use, for example a pouch or container or bag is a bounded volume for containing the pigment medium (e.g., ink, paint, etc.), all without departing from the scope and spirit of the present invention.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A screen printing system, the system for applying an indicia design to a substrate, said system comprising:
a substantially rigid support having at least one straight edge, said support containing a substantially planar portion proximate said straight edge;
a packet containing an ink medium and having at least a first edge operably secured to said support proximate said at least one straight edge and said planer portion; and
said first edge of said packet substantially aligned to said at least one straight edge and containing a defined access region for externally accessing said ink medium during a use.

2. The screen printing system, according to claim 1, wherein said rigid support is plastic and T-shaped at an application edge.

3. The screen printing system, according to claim 1, wherein said ink is selected from the group consisting of magnetic ink, discharge ink, expanding ink, metallic ink, glossy ink, mirrored silver ink, nylobond, plastisol, PVC and phthalate free ink, suede ink, and water-based ink.

4. The screen printing system, according to claim 1, further comprising:
a mesh-like printing screen with paint-blocks having a cutout design being ink-penetrable.

5. The screen printing system, according to claim 4, wherein: said printing screen comprises first and second screens, wherein said first screen includes a cutout of a first portion of said design, and said second screen includes a cutout of a second portion of said design.

6. The screen printing system, according to claim 5, wherein one portion of said design can be applied to said surface through said cutout area of said first screen and said second screen can be placed against said surface with a visibly depicted portion of said design registered with the previously applied portion of said design to align said portions of said design whereupon another portion of said design can be applied to said surface through said cutout area said second screen.

7. The screen printing system, according to claim 5, wherein said print screens each comprise registration marks so that said portions of said design on said first screen are visible through said cutout areas of said second screen to present a completed image of said design for reference.

8. The screen printing system, according to claim 6, wherein said registration marks comprise an array of lines.

9. The screen printing system, according to claim 4, wherein said print-screen is coated with a layer of adhesive material on a first side, peelablely attached and protected by a non-porous sheet, wherein said first side is used to stick to a surface to be painted on.

10. The screen printing system, according to claim 1, wherein said paint packet contains a pre-cut slit at an application side that is sealed with a releasably adhered sticky-strip.

11. The screen printing system, according to claim 1, wherein said paint packet is sealed and is cut at provided at said defined access region at said use.

12. A screen printing method, for applying a design to a substrate using a handheld applicator having an ink packet attached to a rigid support surface, said method comprising the steps of:
positioning on a surface a print screen having a cutout design thereon;
in a handheld applicator having an ink packet attached to a rigid support surface;
pushing an ink in said packet substantially toward a proximate end of said packet, said support surface having a substantially straight bottom edge;
creating an opening in said packet of ink substantially near a bottom end of said packet;
positioning said applicator such that said bottom edge of said support surface is in contact with said screen;
moving said applicator continuously in a longitudinal direction continuously across said screen while depressing on said packet such that said ink is forced out of said packet via said cutout;
repositioning said applicator in a second position on said screen and repeating said moving step until said cutout has been filled with said ink; and
removing said screen from said surface.

13. The screen printing method according to claim 12, wherein said ink is selected from the group consisting of magnetic ink, discharge ink, expanding ink, metallic ink, glossy ink, mirrored silver ink, nylobond, plastisol, PVC and phthalate free ink, suede ink, and water-based ink.

14. The screen printing method according to claim 12, wherein said print screen comprises first and second screens, wherein said first screen includes a cutout of a first portion of said design, and said second screen includes a cutout of a second portion of said design.

15. The screen printing method according to claim 12, wherein one portion of said design is applied to said surface through said cutout area of said first screen and said second screen is placed against said surface with a visibly depicted portion of said design registered with the previously applied portion of said design to align said portions of said design whereupon another portion of said design can be applied to said surface through said cutout area said second screen.

16. The screen printing method according to claim 12, wherein said print screens each comprise registration marks so that said portions of said design on said first screen are visible through said cutout areas of said second screen to present a completed image of said design for reference.

17. The screen printing method according to claim 16, wherein said registration marks comprise an array of lines.

18. The screen printing system, according to claim 12, wherein said print-screen is coated with a layer of adhesive material on a first side, peelablely attached and protected by a non-porous sheet, wherein upon use, said non-porous sheet is peeled off, exposing said first side that is used to stick to a surface to be painted on.

19. The screen printing system, according to claim 12, wherein said paint packet contains a pre-cut slit at an application side that is sealed with a peelable sticky-strip.

20. The screen printing system, according to claim 12, wherein said paint packet is sealed and is cut at slit at an application side at the time of use.
